(19) United States
(12) Patent Application Publication
(10) Pub. No.: US 2002/0114096 A1
(43) Pub. Date: Aug. 22, 2002

(54) Apparatus and method for retrieving data cartridge information in a cartridge receiving device

(76) Inventors: Richard Lynn Gardner JR., Greeley, CO (US); Paul C. Coffin, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/790,856

(22) Filed: Feb. 22, 2001

(51) Int. Cl. G11B 15/18

(52) U.S. Cl. 360/69; 360/71

(57) ABSTRACT

An apparatus and method for retrieving data cartridge information associated with a data cartridge contained in a cartridge receiving device of a media storage system. An identification device is attached to the data cartridge for storing the data cartridge information and a reader is attached to the cartridge receiving device adjacent the data cartridge for reading the data cartridge information from the identification device. The identification device transmits a data signal containing the data cartridge information to the reader. A controller operatively associated with the reader may process the data signal.

### FIELD OF THE INVENTION

The invention pertains generally to retrieving data cartridge information associated with a data cartridge, and more specifically, to retrieving the data cartridge information from the data cartridge when the same is located in a cartridge receiving device of the media storage system.

### BACKGROUND OF THE INVENTION

Media storage systems are well-known in the art and are commonly used to store data cartridges at known locations and to retrieve desired data cartridges so that data may be written to or read from the data cartridges. Such media storage systems are often referred to as autochanger media storage systems or, simply, autochangers.

A typical autochanger or media storage system may include one or more different types of cartridge receiving devices for holding the various data cartridges. For example, one type of cartridge receiving device may comprise an individual cartridge storage location or slot (e.g., for holding a single data cartridge, such as in a “mail slot”) or a cartridge storage rack or “magazine” (e.g., for holding a plurality of data cartridges). Another type of cartridge receiving device may comprise a cartridge read/write device for reading data from or writing data to the data cartridges contained in the autochanger. The cartridge storage slots or magazines serve to provide storage locations for the data cartridges and are commonly arranged so that they form one or more vertical stacks, although other arrangements are possible.

The autochanger or media storage system may also be provided with a cartridge handling system for transporting the data cartridges between the various cartridge receiving devices (e.g., between the cartridge storage locations and the cartridge read/write devices). A typical cartridge handling system may include a cartridge engaging assembly or “picker” for engaging the various data cartridges contained in the cartridge receiving devices, as well as a positioning device for moving the cartridge engaging assembly among the various cartridge receiving devices.

Autochangers or media storage systems of the type described above are usually connected to a host computer system which may access or store data on the data cartridges. For example, if the host computer system issues a request for data contained on a particular data cartridge, a control system associated with the autochanger actuates the positioning system to move the cartridge engaging assembly or “picker” along the cartridge storage locations until the cartridge engaging assembly is positioned adjacent the desired data cartridge. The cartridge engaging assembly may then remove the data cartridge from the cartridge storage location and carry it to the cartridge read/write device. Once properly positioned adjacent the cartridge read/write device, the cartridge engaging assembly may insert the selected data cartridge into the cartridge read/write device so that the host computer may thereafter read data from or write data to the data cartridge. After the read/write operation is complete, the cartridge engaging assembly may remove the data cartridge from the cartridge read/write device and return it to the appropriate cartridge storage location.

Since most such media storage systems contain a large number of individual data cartridges, some means is usually provided to allow the media storage system to identify and locate the desired data cartridge. Most media storage systems utilize an “inventory map” which contains information relating to each data cartridge as well as its location within the media storage system. The media storage system utilizes the inventory map to move the various data cartridges within the media storage system to the proper locations and at the proper times.

One common means for generating and updating such an inventory map is to provide each data cartridge with an identification tag or label (e.g., a bar code label) that contains certain information relating to the data cartridge. By way of example, the data cartridge information may include data that uniquely identify the data cartridge as well as data relating to the type or classification of the data contained in the cartridge. The picker is provided with a suitable reading device (e.g., a bar code reader) which allows the data cartridge information to be read from the data cartridge as the picker is moved about the media storage system. The cartridge information for each data cartridge, along with its corresponding storage location within the media storage system, is then used to generate and/or update the inventory map. Thus, when the media storage system is first placed into operation, or restarted during a power cycle, the picker is moved about the media storage system and the reading device provided therewith examines the tag or label provided on each data cartridge to ascertain its identity, and then instructs the media storage system as to its location. This procedure must be repeated for each individual data cartridge. This can be particularly burdensome and/or time consuming where the media storage system contains a large number of data cartridges.

It is often necessary or desirable for a system operator to periodically access one or more of the data cartridges contained within such a media storage system. For example, it may be necessary for the system operator to remove certain of the data cartridges from time to time if they become filled with data that is to be archived at another location. The system operator may then replace the filled data cartridges with blank data cartridges. In another situation, the system operator may desire to remove one or more of the data cartridges and replace it or them with a substitute data cartridge or cartridges containing different data.

Regardless of the reason for adding, removing, or replacing one or more of the data cartridges, the media storage system will need to re-inventory the data cartridges before it can be returned to operation. That is, the picker must be moved adjacent each of the added or replaced data cartridges so that each can be identified and inventoried in the media storage system. While the need to re-inventory the data cartridges may not be particularly burdensome in some cases, it can be particularly burdensome and/or time consuming if the data cartridges are exchanged frequently or if the media storage system contains a large number of data cartridges.

### SUMMARY OF THE INVENTION

Apparatus for retrieving data cartridge information associated with a data cartridge contained in a cartridge receiving device may comprise an identification device mounted to the data cartridge. The identification device contains the data cartridge information. A reader is mounted to the cartridge receiving device and is operable to read the data cartridge information contained on the identification device when the data cartridge is positioned in the cartridge receiving device.

Also disclosed is a method for retrieving data cartridge information associated with a data cartridge in a cartridge receiving device, which may comprise the steps of: positioning the data cartridge in the cartridge receiving device; transmitting a data signal containing the data cartridge information from an identification device attached to the data cartridge; and receiving the transmitted data signal at a reader attached to the cartridge receiving device.

### BRIEF DESCRIPTION OF THE DRAWINGS

Illustrative and presently preferred embodiments of the invention are illustrated in the drawings in which:

FIG. 1 is a plan view of a storage system that utilizes the apparatus for retrieving data according to one embodiment of the invention;

FIG. 2 is a perspective view of an exemplary cartridge receiving device for use with the storage system;

FIG. 3 is a simplified, plan view of the cartridge receiving device in FIG. 2 containing a data cartridge, wherein a reader attached thereto is in close proximity to an identification device mounted to the data cartridge;

FIG. 4 is a plan view of an exemplary reader; and

FIG. 5 is a plan view of an exemplary identification device.

### DESCRIPTION OF THE PREFERRED EMBODIMENT

Apparatus 10 for retrieving data cartridge information associated with a data cartridge 20 is shown and described herein as it could be used with a data or media storage system 15. Briefly, media storage systems 15 are used to store large volumes of computer readable data. The computer readable data is typically stored on multiple data cartridges 20 that are arranged in one or more cartridge receiving devices of the media storage system 15 (e.g., in storage magazines 30). The media storage system 15 may include a cartridge engaging assembly 40 that can be moved among the cartridge receiving devices and positioned adjacent a data cartridge 20 therein, according to an inventory map for accessing the data cartridges 20 stored therein. The inventory map must be created before the media storage system 15 can be placed into operation, and the inventory map must be updated each time a new data cartridge 20 is added and/or returned to the media storage system 15. It is therefore desirable to quickly and efficiently identify individual data cartridges 20 with as much information that is possible. The present invention relates to such a method and apparatus for reading the data cartridge information from each of the data cartridges 20 in the media storage system 15.

According to the invention, each data cartridge 20 may be provided with an identification device 150 thereon. The cartridge receiving device may be provided with one or more readers 140 thereon that are operable to read the identification device 150 when the data cartridge 20 is contained in the cartridge receiving device. Accordingly, the identification device 150 may be operated to obtain cartridge information on each data cartridge 20 while the same remains in the cartridge receiving device.

The apparatus 10 may be operated as follows to allow the system operator to retrieve the data cartridge information from each of the data cartridges 20 in the media storage system 15. The data cartridge 20 is positioned in a storage slot 75 of the cartridge receiving device (e.g., storage magazine 30) by a system operator, using the picker 40, etc. The data cartridge 20 is positioned in such a manner so that the identification device 150 that is attached to the data cartridge 20 is adjacent the reader 140 that is mounted to the cartridge receiving device. The identification device 150 transmits a data signal containing the data cartridge information, which is received at the reader 140 and processed by the controller 147. For example, the data cartridge information may be displayed for a user browsing the media storage system 15, used to create an inventory for immediate or later use, used to identify a requested data cartridge 20, etc.

Accordingly, the data cartridge information can be read from one or more data cartridges 20 in the media storage system 15 without having to individually identify each data cartridge 20 using the picker 40. Indeed, the data cartridge information may be read simultaneously or nearly simultaneously from more than one data cartridge 20 in the media storage system 15. As such, and by way of example, each data cartridge 20 stored in the media storage system 15 may be readily and automatically inventoried.

It is also important to recognize that in some embodiments (e.g., where the identification device 150 is a radio frequency identification (RFID) transponder), extensive data cartridge information may be obtained and/or the data cartridge information can be rewritten.

Having generally described methods and apparatus for retrieving data cartridge information associated with a data cartridge 20 in a media storage system 15 and several advantages thereof, the methods and apparatus will now be described in further detail.

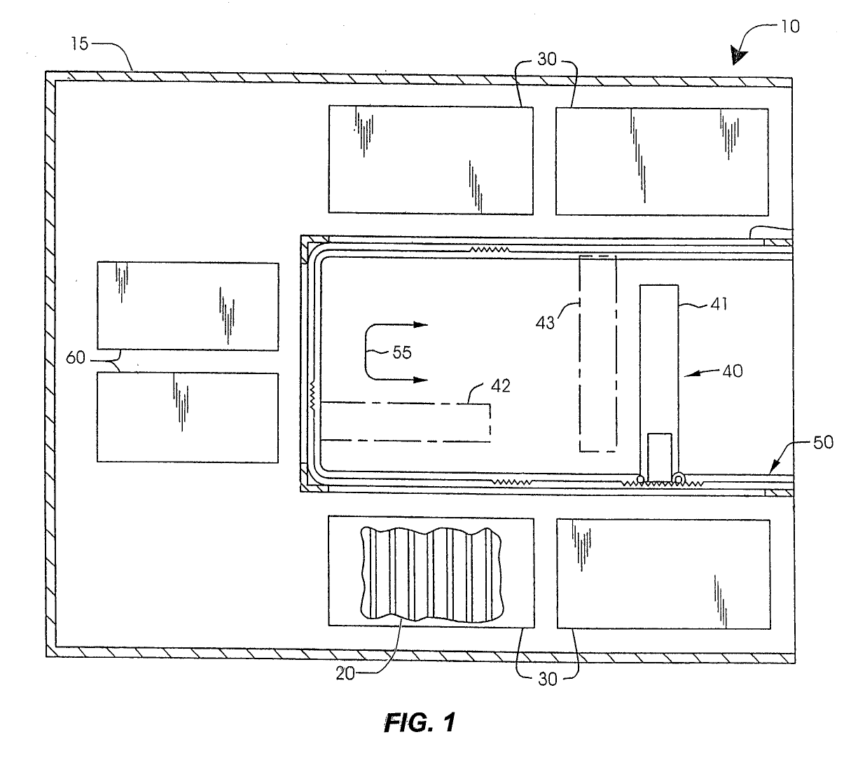

The apparatus 10 for retrieving the data cartridge information associated with a data cartridge 20 may comprise an autochanger or media storage system 15 such as that shown in FIG. 1. The media storage system 15 includes one or more data cartridges 20 arranged in one or more cartridge receiving devices (e.g., storage magazine 30, read/write device 60, a mail slot (not shown), etc.). In use, a control system (not shown) associated with the media storage system 15 moves a cartridge engaging assembly 40 (i.e., a “picker” and a positioning device) along a positioning rail 50 adjacent the cartridge receiving device(s) to access and deliver the data cartridge(s) 20 according to requests by a host computer (not shown). That is, the host computer linked to the media storage system 15 (e.g., via a direct connection, remote connection, network connection, etc.) may issue a request to access a data cartridge 20 stored in one of the storage magazines 30 to read and/or write data thereto. In response, the control system moves the cartridge engaging assembly 40 along the positioning rail 50 (i.e., in the directions of arrow 55). The control system positions the cartridge engaging assembly 40 adjacent the requested data cartridge 20 (e.g., according to an inventory map). Once positioned, the control system signals the cartridge engaging assembly 40 to withdraw the data cartridge 20 from the storage magazine 30 and to carry it to the read/write device 60 where the linked computer can read and/or write computer readable data thereon.

In order to locate the data cartridge 20 within the media storage system 15, it may be desirable to create and/or maintain an inventory map for use by the media storage system. As such, each data cartridge 20 may be provided with an identification device 150 thereon and the cartridge receiving device (e.g., the storage magazine 30) may be provided with one or more readers 140 thereon. The identification device 150 may be read to obtain cartridge information on each data cartridge 20 when the data cartridge 20 is contained in the cartridge receiving device.

The media storage system 15 may include one or more different types of cartridge receiving devices. For example, the cartridge receiving device may be a storage magazine 30 or a “mail slot” (not shown), and may comprise an individual cartridge storage location or a plurality thereof for holding or containing one or more data cartridges 20. Or for example, the cartridge receiving device may comprise a cartridge read/write device 60 for reading and/or writing data on a data cartridge 20. Although the invention is shown and described with respect to a storage magazine 30, the scope of the invention is intended to also include other cartridge receiving devices.

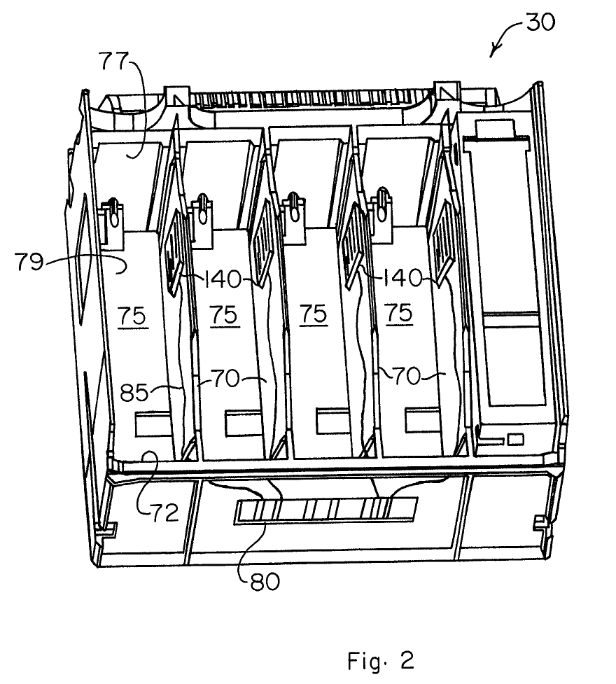

An exemplary cartridge receiving device (i.e., storage magazine 30), for use with the media storage system 15, is shown in FIG. 2. The storage magazine 30 may comprise a frame assembly defining a cavity or chamber(i.e., storage slot 75) sized to receive the data cartridge 20 therein. That is, the frame assembly includes opposing partitions or side walls 70, and may also include a bottom wall 72, a top wall 77, and a rear wall 79, that define one or more storage slots 75 in the storage magazine 30.

It is understood that the storage magazine 30 may include any number of partitions 70 forming any number of storage slots 75 therein. In addition, the storage slots 75 may be any suitable size to contain the data cartridge 20 therein. It is also understood that the storage magazine 30 may take any suitable form. For example, the storage magazine 30 need not be removable and may instead be an integrally formed or permanently mounted series of partitions within the media storage system 15. Also for example, the partitions 70 and indeed walls 72, 77 and 79 need not be solid partitions, any particular thickness or dimension, etc.

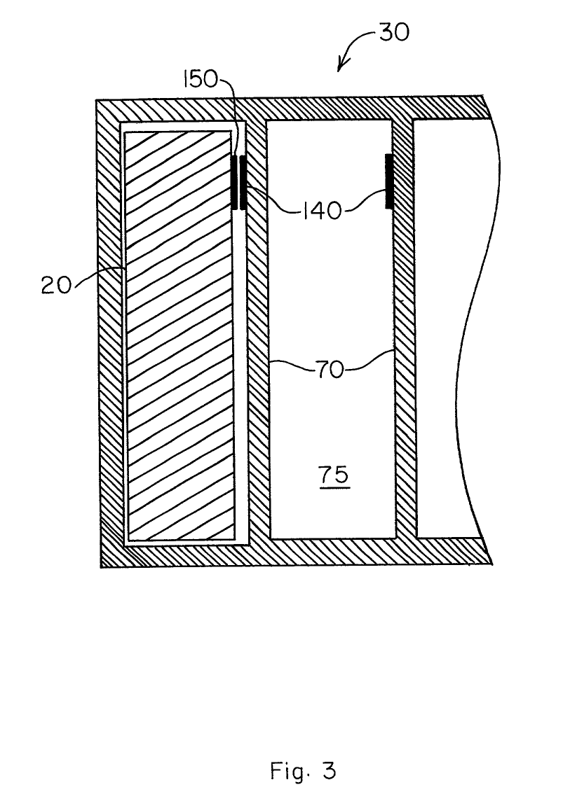

According to the teachings of the invention, a reader 140 is mounted to the cartridge receiving device (e.g., the storage magazine 30). The reader 140 is preferably mounted on the sidewall or partition 70 of each storage slot 75, as shown in FIG. 2 and FIG. 3. In addition, an identification device 150 containing the data cartridge information is mounted to each cartridge 20, as shown in FIG. 3. Thus, the data cartridge 20 may be positioned in the storage slot 75 so that the reader 140 is within the transmission range of the identification device 150 so that the reader 140 may read the data cartridge information from the identification device 150.

It is understood, that the reader 140 can be positioned in any suitable manner within the storage slot 75 of the storage magazine 30, and that the identification device 150 can be positioned in any suitable manner on the data cartridge 20. For example, the reader 140 may be mounted to the partition 70 on either side of the storage slot 75. Or for example, the reader 140 may be mounted near the front of the storage magazine 30 (e.g., shown in FIG. 2), or near the back, near the middle, near the top, or near the bottom of the storage magazine 30. Or for example, the reader 140 may be mounted diagonally, etc. Alternatively, the reader 140 may be mounted on the storage magazine 30 to the bottom wall 72, to the top wall 77, or to the back wall 79 of the storage slot 75. Likewise, the identification device 150 is preferably similarly mounted to the data cartridge 20 so that the reader 140 and the identification device 150 are adjacent one another when the data cartridge 20 is positioned in the storage slot 75 of the storage magazine 30 (e.g., FIG. 3). It is further understood that the identification device 150 and/or the reader 140 can be embedded in the data cartridge 20 and the storage magazine 30, respectively, or attached using any other suitable means (e.g., adhesive, integrally formed therein, etc.).

The readers 140 are preferably wired (e.g., via line 85) to a slip connector 80 (FIG. 2). A mating slip connector (not shown) is also preferably provided as part of the media storage system 15 and wired, or otherwise linked, to the controller 147. As such, when the cartridge receiving device (e.g., storage magazine 30) is positioned in the media storage system 15, the slip connector 80 contacts the mating slip connector, thereby completing the circuit between the readers 140 and the controller 147. In addition, when the cartridge receiving device is removed from the media storage system 15, the circuit is interrupted and the controller can signal the user that the cartridge receiving device has been removed. However, it is understood that the readers 140 may be linked to the controller 147 using any suitable means including via permanent hardwired connections, wireless connections (e.g., radio frequency or RF), infrared (IR), etc.

Preferably, an air interface (e.g., about three millimeters) is formed between the reader 140 and the identification device 150 when the data cartridge is positioned in the storage slot 75 (FIG. 3). As such, the reader 140 need not physically contact the identification device 150. However, the invention is not to be limited to the preferred transmission range of three millimeters. In other embodiments, the reader 140 may be less than three millimeters and may even contact the identification device 150. Likewise, the transmission range can be greater than three millimeters. The transmission range may vary under the teachings of the present invention and may depend on design considerations such as the transmission and receiving capabilities of the reader 140 and the identification device 150, the likelihood of interference or crosstalk, etc. Other design considerations may include the respective power requirements of the reader 140 and the identification device 150, the signal detection capability of the reader 140, the transmission frequencies, the rate of transmission, etc.

It is understood that each data cartridge 20 can have multiple identification devices 150 mounted thereto, and multiple readers 140 may be provided within a single cartridge receiving cavity (e.g., storage slot 75 in storage magazine 30). As an example, a data cartridge 20 may have an identification device 150 mounted to either side thereof. As such, the data cartridge 20 can be used in a cartridge receiving device having a reader on one side of the storage slot 75, and in another cartridge receiving device having a reader 150 on the opposite side thereof. As another example, a data cartridge 20 may have multiple identification devices 150, and each cartridge receiving cavity may have multiple readers 140. As such, each identification device 150 may contain different data cartridge information. Other embodiments are also contemplated as being within the scope of the teachings of the invention.

The reader 140 and the identification device 150 preferably use RFID technology. Generally, RFID transponders have small power requirements (e.g., in the microwatt to milliwatt range), and can be passive, active, or a combination thereof. That is, a passive RFID transponder derives power from a magnetic or electric field generated by the reader, while an active RFID transponder is self-powered by an internal battery. A combination passive/active RFID transponder is powered by an internal battery, but only draws power from the battery after being passed through a high energy activation field. RFID technology is well understood in the art.

It is understood, however, that the reader 140 and the identification device 150 are not limited to RFID technology. Indeed, the reader 140 and the identification device 150 can include other storage and communication systems now known or later developed for storing and reading the data cartridge information, such as, but not limited to a bar code label and a bar code reader operatively associated with a suitable controller.

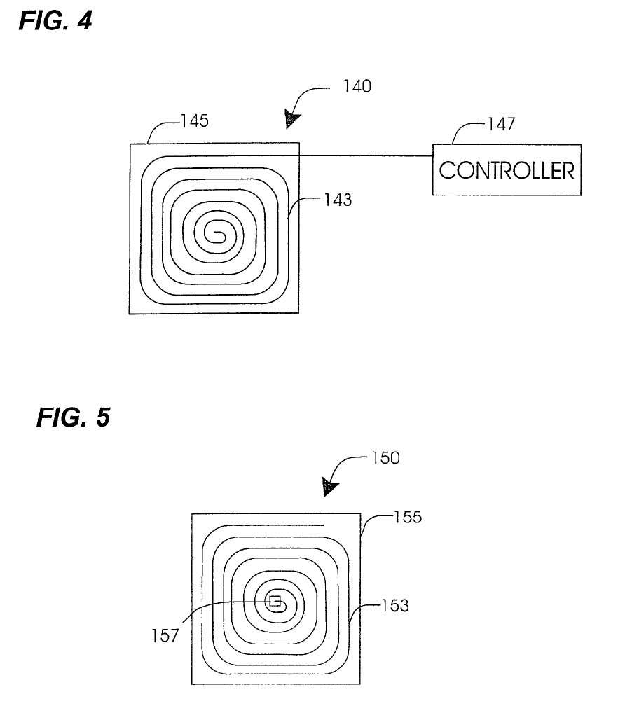

An exemplary reader 140 (e.g., an RFID reader) is shown in FIG. 4. The RFID reader includes an antenna 143 (e.g., numerous turns of a fine wire to form a coil) etched on a flexible printed circuit substrate 145. The reader 140 is operatively associated with a controller 147. That is, the controller 147 is linked (via a direct or remote connection) with the reader 140 for communicating therebetween. For example, where the reader 140 is an inductive reader, the controller 147 may cause an electrical current to pass through the antenna 143, thus generating an energy field for activating the identification device 150. Once the identification device 150 is activated, the controller may transmit an interrogation signal through the antenna 143 querying the identification device 150. Likewise, when the reader 140 receives a response or a data signal from the identification device 150, the data signal is delivered to the controller 147 for further processing. For example, the controller may convert the data signal into user-readable data for output at a computer, generate or update an inventory database with the data relating to the data cartridge 20 contained in the data signal, etc. Although the controller 147 is shown separate from the circuit board 145, the reader 140 and the controller 147 can be fabricated together on a single circuit board (e.g., as an integrated circuit).

It is understood that the controller 147 and the reader 140 include any required circuitry and software or firmware for performing the functions as described herein. The design of such controllers and readers is well known in the art. In addition, the controller 147 and the reader 140 can be used to perform any suitable functions, such as but not limited to, signal conditioning, parity error checking, correction, etc. Likewise, once the data signal is correctly received at the reader 140 from the identification device 150 and decoded at the controller 147, the controller 147 may instruct the identification device 150, through the reader 140, to cease transmitting. Where the identification device 150 is programmable, the controller 147 and reader 140 can also include circuitry to perform the necessary data modulation/demodulation and data transfer.

An exemplary identification device 150 (e.g., an RFID transponder) is shown in FIG. 5. The RFID transponder preferably includes a low powered integrated circuit (IC) 157 and an antenna 153 (e.g., numerous turns of a fine wire to form a coil) etched on a flexible printed circuit substrate 155. The IC 157 preferably includes a processor (or processing logic) and at least one memory. The processor receives the query signal from the reader 140 at the antenna 153. The processor retrieves data stored on the memory and generates a response or data signal containing the data requested by the query. The data signal is transmitted via the antenna 153 on the identification device 150 (e.g., via radio frequency) and received at the antenna 143 on the reader 140. While the identification device 150 is shown fabricated as a single printed circuit board, the identification device can comprise separate components linked to one another.

The RFID transponder can include any suitable memory. The memory may include Read Only Memory (ROM) for security data and operating system instructions, which in conjunction with the processor, controls internal functions (e.g., response delay timing, data flow control, and power supply switching). The memory may also include Random Access Memory (RAM) to facilitate temporary data storage during query and response. The memory may also include non-volatile programmable memory (e.g., Electrically Erasable Programmable Read Only Memory or EEPROM) to store data cartridge information that is retained therein when the identification device 150 is deactivated or in a power-saving mode. The memory may also include write-once/read many (WORM) memory, wherein the reader 140 and/or controller 147 could be configured (or a separate writing device provided) to write data to the identification device 150 (e.g., an indication of when or how often the data cartridge 20 is accessed). Likewise, data buffers may be used to temporarily hold incoming data following demodulation and outgoing data for modulation and interface with the reader 140. In addition, data stored in memory on the identification device 150 can be conventionally organized using data identifiers and error detection bits (i.e., source encoding).

The RFID transponder preferably stores up to four kilobytes of the data cartridge information. In one embodiment, the data cartridge information can be partitioned. For example, the data cartridge information may include device common information (e.g., remaining capacity, maximum capacity, tape alert flags, etc.), medium common attributes (e.g., manufacturer, serial number, etc.), and host common attributes (e.g., vendor, version, date last written, etc.). Likewise, the identification device 150 may include permanent data and rewritable data. However, it is understood that the quantity of data stored on the identification device 150 can vary depending on the design characteristics of the identification device 150, the type of data stored thereon, etc. It is also understood that the type of data that is stored on the identification device 150 is immaterial to the scope of the present invention. For example, a user identification or passcode can be stored on the identification device 150 and suitable software can be provided to manage access to the data cartridge 20 based on the user identification and/or passcode. Such software can be readily developed by one skilled in the art.

It should be noted that although the apparatus and method of the present invention is illustrated using a particular media storage system 15, the teachings of the invention may be utilized in any of a wide range of media storage systems now known in the art or that may be developed in the future for accessing or taking inventory of one or more data cartridges 20. Accordingly, the present invention should not be regarded as limited to the particular media storage system 15 shown and described herein. It should also be noted that while the cartridge access device 40 is shown and described herein as it could be used to store and retrieve a linear tape open (LTO) data cartridge 20 having a standard size and configuration, it is not limited to any particular type or style of data cartridge. Indeed, the cartridge access device 40 according to the present invention could be used with any type of media storage system comprising any type of storage medium (e.g., magnetic disk or tape, optical disk, etc.). Consequently, the present invention should not be regarded as limited to use with the media storage system 15 for the LTO data cartridge 20 shown and described herein.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. An apparatus for retrieving data cartridge information associated with a data cartridge contained in a cartridge receiving device, comprising:
an identification device mounted to the data cartridge, said identification device containing the data cartridge information; and
a reader mounted to the cartridge receiving device, said reader operable to read the data cartridge information contained on said identification device when the data cartridge is positioned in the cartridge receiving device.

2. The apparatus of claim 1, further comprising a controller operatively associated with said reader, said controller operating said reader to query said identification device to transmit said data signal, said controller responsive to said transmitted data signal.

3. The apparatus of claim 2, wherein said controller operates said reader to activate said identification device.

4. The apparatus of claim 1, wherein said reader is mounted in a storage slot of the cartridge receiving device.

5. The apparatus of claim 1, wherein said identification device comprises a passive identification device, and wherein said reader activates said passive identification device so that said passive identification device transmits a data signal containing the data cartridge information, said reader responsive to said transmitted data signal.

6. The apparatus of claim 1, wherein said identification device comprises an active identification device.

7. The apparatus of claim 1, wherein said identification device is a radio frequency identification (RFID) transponder.

8. The apparatus of claim 1, wherein the data cartridge information includes at least cartridge identification data.

9. A method for retrieving data cartridge information associated with a data cartridge in a cartridge receiving device, comprising:
positioning said data cartridge in said cartridge receiving device;
transmitting a data signal containing said data cartridge information from an identification device attached to said data cartridge; and
receiving said transmitted data signal at a reader attached to said cartridge receiving device.

10. The method of claim 9, wherein said data cartridge is positioned within a storage slot of the cartridge receiving device with said identification device adjacent said reader.

11. The method of claim 9, further comprising writing at least a portion of the data cartridge information to said identification device.

12. The method of claim 9, further comprising activating said identification device.

13. The method of claim 12, further comprising deactivating said identification device.

14. The method of claim 9, further comprising querying said identification device to transmit said data.

15. The method of claim 9, further comprising processing said transmitted data signal at a controller operatively associated with said reader.

16. An apparatus for retrieving data cartridge information associated with a data cartridge in a cartridge receiving device, comprising:
a storage device attached to the data cartridge for storing the data cartridge information; and
a reader mounted to said storage device, said reader operable to read the data cartridge information stored on said storage device when the data cartridge is positioned in the cartridge receiving device.

17. The apparatus of claim 16, further comprising a processor operatively associated with said reader for processing a data signal containing the data cartridge information.

18. An apparatus for retrieving data cartridge information associated with a data cartridge, comprising:
a cartridge receiving device;
an identification device mounted to the data cartridge, said identification device containing the data cartridge information; and
a reader mounted to said cartridge receiving device, said reader operable to read the data cartridge information contained on said identification device when the data cartridge is positioned in said cartridge receiving device.

19. The apparatus of claim 18, wherein said cartridge receiving device comprises a number of partitions forming a number of storage slots therein for containing said data cartridge, wherein said reader is mounted to at least one of said number of partitions.

20. The apparatus of claim 18, wherein said identification device comprises a transponder, and wherein said reader queries said transponder, said transponder transmitting a data signal containing the data cartridge information in response to said query.

21. The apparatus of claim 18, wherein said cartridge receiving device is a storage magazine.
